(19) United States
(12) Patent Application Publication
(10) Pub. No.: US 2005/0065843 A1
(43) Pub. Date: Mar. 24, 2005

(54) Visual destination

(76) Inventor: Wesley Travis Carlock, Scottsdale, AZ (US)

Correspondence Address: Wesley T. Carlock;Unit 167, 8400 E. Dixileta Drive, Scottsdale, AZ, 85262, US

(21) Appl. No.: 10/664,847

(22) Filed: Sep. 22, 2003

(51) Int. Cl. G06F 17/60

(52) U.S. Cl. 705/14

(57) ABSTRACT

Using a compact disk ram (CD)/digital versatile disk (DVD), or whatever medium available in the future, a company, or conglomerate would be able to showcase and promote all, or any portion thereof, of its properties or subsidiaries domestically in the United States and/or internationally in the six major continents and countries within the region. The DVD will feature an interactive location guide, along with providing narration and graphical text in the video. Each location featured will have a minimum thirty-second segment to an undetermined maximum allotted time. The video will portray the uniqueness and desirability of the facilities. A video will show images of each location; portions of the facilities, amenities, and accommodations available will be showcased as the key selling features. The DVD concept attracts new users, engages user participation and retains loyal patrons.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Using a compact disk (CD-ROM)/digital versatile disk (DVD), mini-disks, laser disks, or whatever medium available in the future, a company, or conglomerate would be able to showcase and promote all, or any portion thereof, of its properties or subsidiaries domestically in the United States and/or internationally in the six major continents and countries within the region.

Each location featured will have a minimum thirty-second segment to an undetermined maximum allotted time. The video will portray the uniqueness of the facilities. A video will show images of each location; portions of the facilities, amenities, and accommodations available will be showcased as the key selling features.

Graphics will be used to identify a particular location website address, along with the names of particular facilities and/or amenities. Voice over narration will also be utilized to compliment the video and graphics.

Hotel chains, cruise ship lines, golf course chains, universities, casinos, restaurant or nightclubs, professional sport teams, and chambers of commerce are just some of the industries who are trying to attract new users or patrons, and retain current users as loyal customers. Some of these entities have a problem promoting their numerous facilities and the amenities within.

### BRIEF SUMMARY OF THE INVENTION

The introduction of this new innovative concept, the Visual Destination Tour, builds on the advantages and capabilities of current and future technology in advertising and marketing practices. The collaboration of DVD, digitalized video production, interactive control menus, and other technologies, will be translated into concrete advertising and promotional materials.

The finished product can be sent via direct mailing to all known prior visitors, those who have inquired about the facility, to competitor's mailing lists, to associated partners and members lists, or given complimentary to patrons upon departure from the facilities, and/or as a remembrance to motivate them to frequent the same or other facilities in the future. The product can also be purchased, at the discretion of the facility.

The patron or prospective customer can then locate all multiple facilities integrated within the company by playing the disk on the DVD player, connected to the television, or CD/DVD players installed in computers or other viewing devices.

This CD/DVD concept entices the users in three specific ways:
1. Attracts the user
2. Engage the user's interest and participation in the destination discovery process
3. Retain users and ensuring their return as loyal patrons.

The end result is a personal interactive medium; a niche in an extremely competitive market, and a mass medium, all functioning simultaneously.

The concept of an interactive video viewed on television, DVD, computer or other viewing medium, is not in competition with the internet, but a complimentary marketing advertising program or tool. The Visual Destination DVD provides the traveler, tourist, businesspersons, etc., and opportunity to view all possible sights or locations of a particular facility, at their leisure, and at virtually no cost.

The Visual Destination program will also promote the interaction with the Internet by graphically showing the individual website address of each location and promoting online booking.

As Internet capability evolves and continues to advance and become mainstream with computers, hand held devices, and wireless capabilities, the Visual Destination video concept can and should be integrated with the Internet for viewing online. Another more advanced advertising medium would be created to expand from stills and slide presentations to moving video, to visually depict the various entities available to the traveler.

### BRIEF DESCRIPTION OF THE SEVERAL VIEWS OF THE DRAWING

FIG. 1. A world map is displayed featuring all continents and a tool bar is located on the screen with the option to scroll to any continent. Once the corresponding continent is highlighted, for example Europe as shown in FIG. 1, the user will be able to proceed to the next screen. Meanwhile, above and below the interactive map, the slide show of pictures of main points of interest within the world will be shown moving from left to right, or right to left.

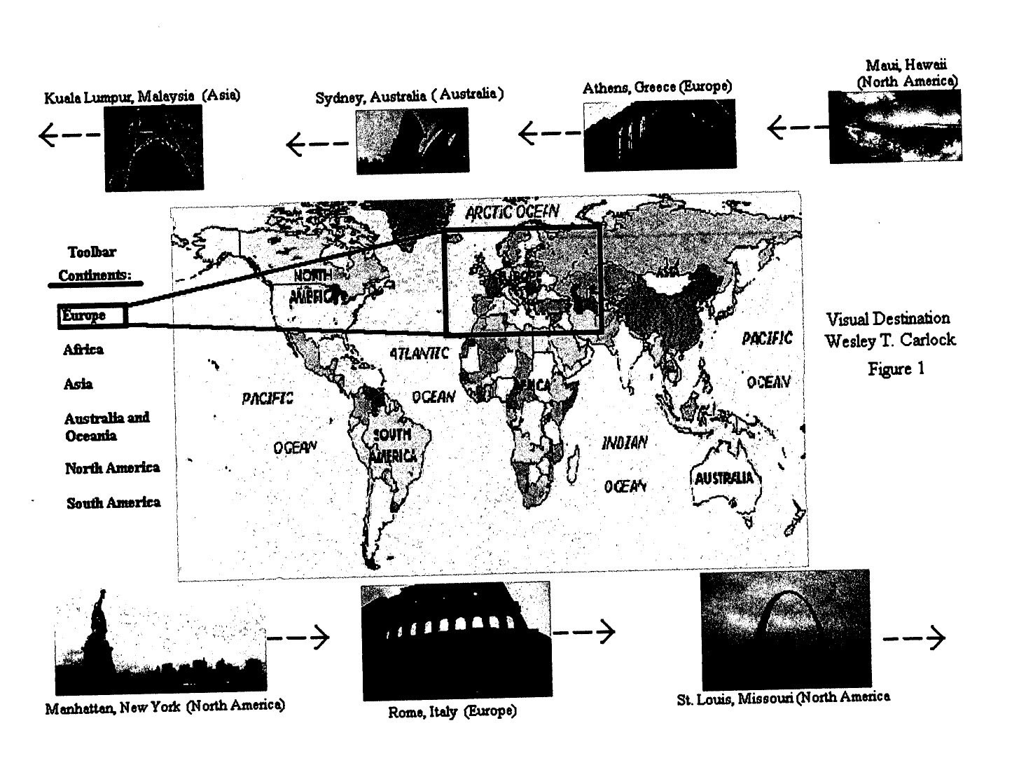

FIG. 2. In this example, the country of Spain was highlighted within the European Continent. Countries were listed in alphabetical order on the tool bar, as well as the options for the previous screen and the main menu. Once the corresponding country is highlighted, as seen in FIG. 2 (Spain), the user will be able to proceed to the next screen. Meanwhile, a slide show of pictures within the continent of Europe will be shown moving from left to right, or right to left.

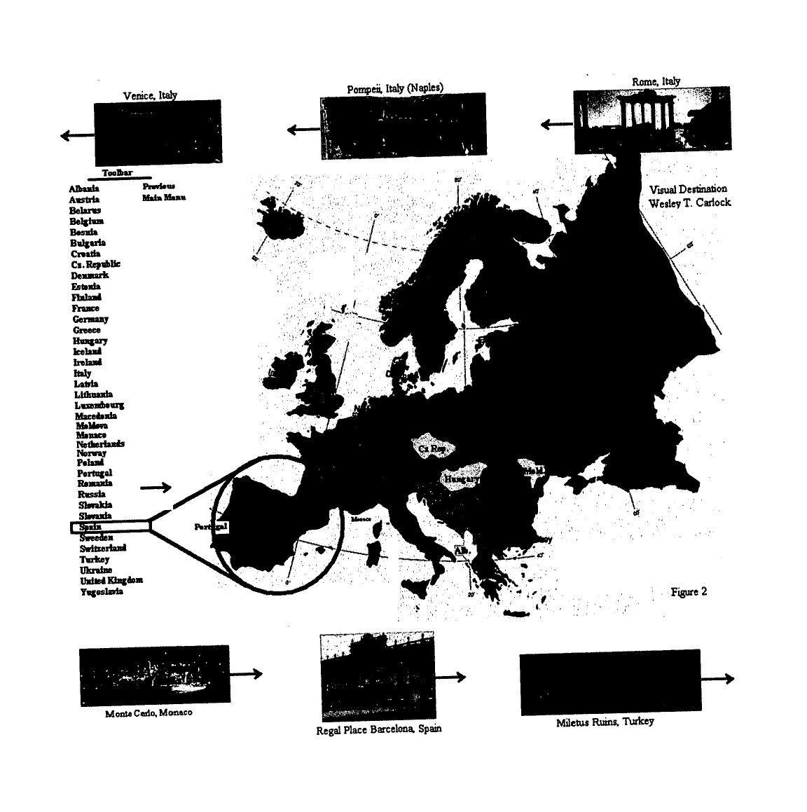

FIG. 3. Once the country is selected, all facilities will be shown in relative position in relation to the country boundaries and city locations. Points of interest are also shown so the user can see the relation of their facility to corresponding attractions. In FIG. 3, Hotel “A”, for example, has four hotels within the country of Spain. These hotels are located on the tool bar and when selected the corresponding graphic of the hotel will be highlighted. The hotel symbol or brand logo will be used as a icon for brand awareness.

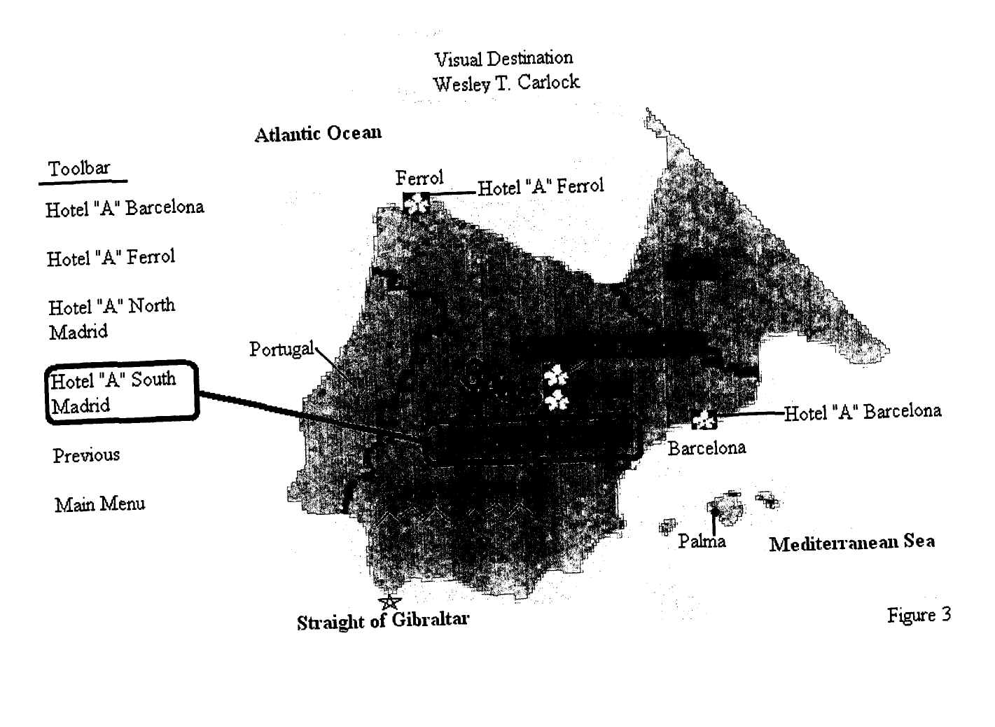

FIG. 4. Once a particular hotel or facility is selected to be viewed, the screen will thank the user for choosing the video for that particular establishment, a tool bar will be available with the common necessities of stop, fast forward, rewind, pause, play, next video, previous screen and main menu. The brand symbol or logo will be magnified and the video will start after a short pause. The tool bar will remain positioned, in an undetermined area, as the video is playing.

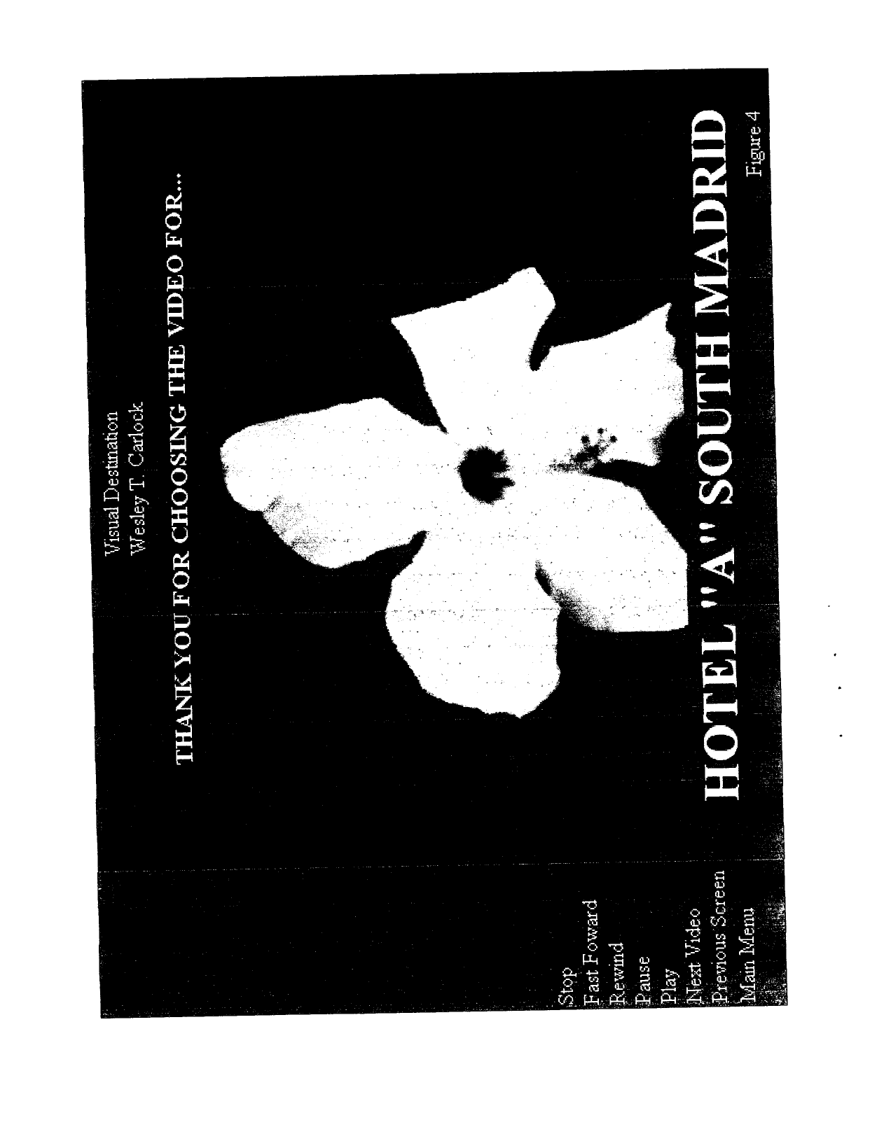

### DETAILED DESCRIPTION OF THE INVENTION

Initially a graphic text welcoming the patron or prospective consumer to the worldwide Visual Destination tour will be seen. After an undetermined amount of time, the greeting dissolves.

The interactive geographical location guide, offered in both United States and international versions, will begin by featuring either a map of the United States, including Alaska and Hawaii (U.S. version) or by featuring a world map for the international version.

International Version—Once the world map is displayed, featuring all continents (North and South America, Australia, Asia, Europe and Africa, and countries within the region), the user will be able to select a particular continent of their choice by using the remote control device(s) such as arrow keys, voice activation, touch pad/screen, and selecting the continent by highlighting the continent on a scroll down menu featured on an undetermined position on the screen. The corresponding continent will be highlighted and then available to be selected by pressing the enter key on the remote control or the devices aforementioned.

After the continent is selected, the world map will dissolve into the background and the selected continent will evolve and be positioned on the screen. All of the countries in the corresponding continent will be featured and the scroll down menu, in an undetermined position, will be available on the screen. The countries will be listed in alphabetical order. The selected and corresponding country will be highlighted on the scroll down menu and will be highlighted on the map as well. Once the desired country is selected and the continent dissolves, the featured country evolves and is positioned on the screen.

Within the featured and selected country, all of the destination locations in relation to the specified country will appear and pin point the relative position to the city and country boundaries. Airports, and other main points of interest, will also be displayed on the map so the user can see where their possible destination is in relation to these main points of interest.

Using the scroll down menu, and ultimately choosing the destination the user wishes to view, the country then fades away and the symbol or brand logo/image of the particular facility or company name will appear for an undetermined amount of time. This image will be positioned in an undetermined area of the screen. The logo or image will then dissolve and the feature visual presentation will be shown for the allotted time for that particular destination.

A tool bar will be provided in an undetermined portion of the screen where the common necessities of fast forward, rewind, pause, play, stop, next video, previous video, and return to main menu icons will be provided. Using the arrow keys on the computer or a remote control device will navigate those available options.

During this selection process, when a continent or country is selected, a slide show of pictures of main points of interest within that continent or country will be shown moving from left to right, or right to left on the top and bottom of the screen. This is to act as a stimulus in the mental thought process of what the selected region has to offer prospective tourists.

Should the user not find the destination of their choice or want to view another destination, country or continent, the steps indicated above would be repeated.

United States Version—The concept remains the same for the United States version. The map of the U.S. would appear along with the states of Alaska and Hawaii. The scroll menu, in the undetermined position on the screen, will be used to select the state the user wishes to visit. States would be listed in alphabetical order. The corresponding state will be highlighted on the map and option to be selected. When a state is selected, the U.S. map dissolves and the selected state will be brought to a bigger size.

All of the destinations within the boundaries of the particular state will be pinpointed to a relative position. Proximity of local points of interest, along with international and municipal airports will be highlighted on the state map.

Using the scroll down menu, and ultimately choosing the destination the user wishes to view, the state then fades away and the symbol or brand logo/image of the particular facility or company name will appear for an undetermined amount of time. This image will be positioned in an undetermined area of the screen. The logo or image will then dissolve and the feature visual presentation will be shown for the allotted time for that particular destination

A tool bar will be provided in an undetermined portion of the screen where the common necessities of fast forward, rewind, pause, play, stop, next video, previous video, and return to main menu icons will be provided. Using the arrow keys on the computer or a remote control device will navigate those available options.

During this selection process, when a state is selected, a slide show of pictures of main points of interest within that state will be shown moving from left to right, or right to left on the top and bottom of the screen. This is to act as a stimulus in the mental thought process of what the selected region has to offer prospective tourists.

Should the user not find the destination of their choice or want to view another state, the steps indicated above would be repeated.

Each company will be contacted and a determination will be made as to how many of their facilities will be included in this DVD video. A video team will be sent to the destinations required by management. They will video the facilities and amenities, along with surrounding recreation and points of interest.

Once all destinations are complete, the video will then be edited, including narration and graphic text.

After editing is complete, the video will then be copied on DVD technology and mass produced for distribution at the discretion of the company or entity involved.

To allocate or share costs of producing the video software, advertising within the video can be sold to local businesses such as restaurants, golf courses, associated partners, airlines, hotels, etc. Included in the fees would be the mention of their location in relation to the featured destination, or video footage to entice the patron to consider their location on the visit to the main destination.

Sequence Listing:

Not applicable

1. What I claim as my invention is to effectively compile all current technologies, i.e., DVD, video production, interactive control menus and other technologies, into an individual DVD marketing tool, which will be used as a new revolutionary and innovative way of advertising, promoting and marketing the immense amount of facilities that companies operate. Companies which monitor or administrate hotels, cruise lines, chambers of commerce, golf courses, universities, restaurants, nightclubs, casinos, etc. need another business method to successfully reach new consumers or maintain loyal patrons.
